(19) United States
(12) Patent Application Publication
(10) Pub. No.: US 2006/0139083 A1
(43) Pub. Date: Jun. 29, 2006

(54) Modifying clock signals output by an integrated circuit

(75) Inventor: Ban Hok Goh, Singapore (SG)

Correspondence Address: SLATER & MATSIL LLP, 17950 PRESTON ROAD, SUITE 1000, DALLAS, TX, 75252, US

(73) Assignee: Infineon Technologies AG

(21) Appl. No.: 11/353,447

(22) Filed: Feb. 14, 2006

Related U.S. Application Data
(63) Continuation of application No. PCT/SG03/00193, filed on Aug. 14, 2003.

(51) Int. Cl. G06F 1/04

(52) U.S. Cl. 327/291

(57) ABSTRACT

An integrated circuit of the kind which transmits a clock-signal off-chip to a load (7) is provided with a load measurement circuit (4), which measures a load value indicative of the power being drawn from the IC by the clock output (5), and a comparison circuit (13), which compares the load value to a “high” load value (21) and a “low” load value (17). The integrated circuit stops transmitting the clock signal off-chip if the measured load value is above the “high” load value (21), indicating that the power drawn may be beyond the operational limits of the integrated circuit. Also, the integrated circuit stops transmitting the clock signal off-chip if the measured load value is below the “low” load value (17), indicating that the clock signal is unused.

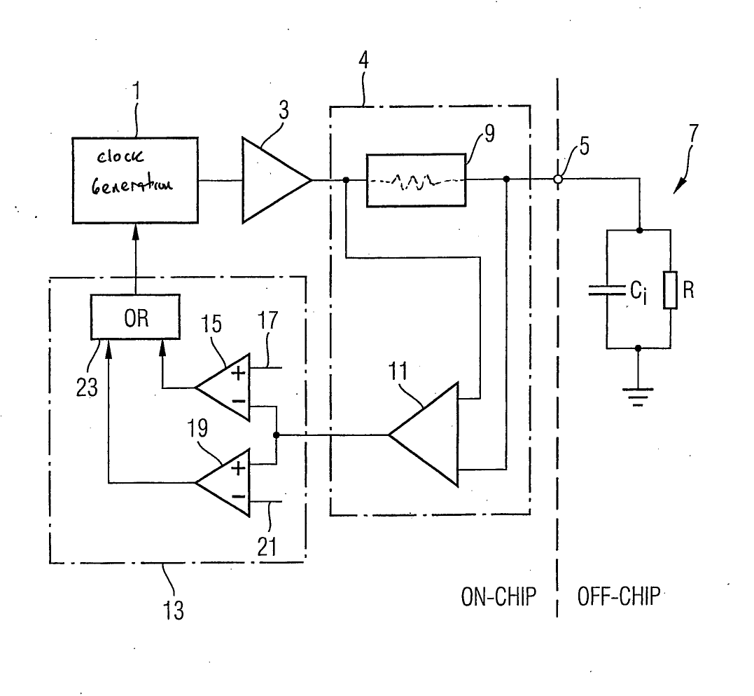

This application is a continuation of co-pending International Application No. PCT/SG2003/000193, filed Aug. 14, 2003, which designated the United States and was published in English, which application is incorporated herein by reference.

### TECHNICAL FIELD

The present invention relates to an integrated circuit of the sort which is capable of generating and outputting a clock signal.

### BACKGROUND

Some integrated circuits (ICs) are designed to output a clock signal, which can be provided to one or more other components of a system (e.g., a computer system), for example to ensure synchrony between the components. Some hardware designers make use of this feature, but others do not, especially in the case that the clock signal is at a fixed frequency, and therefore only has the function of ensuring synchrony. Yet other hardware designers use the clock signal to drive too many loads, overloading the capacity of the integrated circuit and creating clock-related problems such as clock jitter, i.e., an unstable clock, which affects the signal integrity.

U.S. Pat. No. 5,754,069 discloses an integrated circuit in which a clock pulse generator sends clock signals to multiple drivers that amplify the clock pulses and transmit them off the chip through dedicated chip output terminals. In this disclosure, the clock signals are provided from the clock pulse generator to the drivers via respective gate units, and each of the drivers is associated with sensor circuitry, which is operative to provide a cut-off signal to the respective gate. When it receives the cut-off signal, the gate stops transmitting the clock signal to the driver, which therefore stops the clock signal from being transmitted off-chip. In one of the embodiments discussed in the document, the sensor circuitry provides this cut-off signal to the gate when it senses that the line to which the clock output is connected is earthed, which for some hardware designs implies that there is no component attached to that clock output. This reduces both the chip's power consumption and unwanted EMI (electromagnetic interference). In other embodiments, the gate disables the clock outputs for a predefined period after power-up.

### SUMMARY OF THE INVENTION

The present invention aims to provide a new and useful integrated circuit, which generates a clock-signal for transmission to other components.

In general terms, the present invention proposes that the integrated circuit is provided with a load measurement circuit that measures a load value indicative of the power load being drawn from the IC by the clock output, and a comparison circuit that compares the load value to one or more predetermined load threshold values. The integrated circuit stops transmitting the clock signal off-chip according to the result of the comparison.

Preferably, the predetermined load threshold values include at least a “high” load threshold value. If the measured load value is above this “high” load threshold value, then the power drawn may be beyond the operational limits of the integrated circuit, such that the integrity of the computer system may be compromised, so the comparison circuit stops the integrated circuit transmitting the clock signal off-chip.

Preferably, the predetermined load threshold values also include a “low” load threshold value. If the measured load value is below this “low” load threshold value, then this may indicate that the clock signal is unused. Thus, the comparison circuit turns off the clock signal to reduce power consumption by the integrated circuit and also the risk of EMI. The “low” load value may be selected to correspond to zero load, but may also be selected to correspond to a higher load. In contrast to the circuit disclosed in U.S. Pat. No. 5,754,069, the concept of stopping the clock signal from being transmitted based on a measurement of load, means that the clock signal is not transmitted unnecessarily even in situations in which the clock output is not connected to ground. This is indeed a common situation, since the clock signal may be fed to a circuit location which is at non-zero voltage but which for some reason is inactive, or to a location, which carries a low amplitude signal irrelevant to the clock signal (e.g., a noise signal).

Preferably, the load measurement circuit comprises a resistive element in series with the clock output and an element for deriving a difference signal between the voltages at the respective sides of the resistive element.

Note that the mechanism for stopping the clock signal being transmitted varies in different embodiments of the invention. The comparison circuit may, for example, be arranged to be capable of turning off the clock pulse generator completely. Alternatively, the comparison circuit may be able to open a switch element between the clock pulse generator and the clock output (e.g., a switch between the clock pulse generator and a driver which amplifies the clock pulse before it is transmitted off-chip). The comparison circuit may be resettable, i.e., such that it can be made to revert into a state in which it permits the clock signal to be transmitted off chip. It may be arranged to be resettable, for example, by a signal transmitted to it (e.g., by a timing circuit), or it may include its own reset circuit, which resets it (e.g., a predetermined time after issuing the cut-off signal), so that a further measurement of the load may be made.

Specifically, the present invention proposes an integrated circuit having: a clock signal generation unit for generating a clock signal for transmission off the chip through a clock signal output pin, a load measurement circuit which measures a load value indicative of the power load being drawn from the integrated circuit from the clock signal output pin, and a comparison circuit for comparing the load value to one or more predetermined load thresholds and which is operative to prevent the clock signal from being transmitted through the clock signal output pin according to the result of the comparison.

### BRIEF DESCRIPTION OF THE DRAWINGS

Preferred features of the invention will now be described, for the sake of illustration only, with reference to the FIGURE, which shows schematically the configuration of clock signal generation circuit in an integrated circuit, which is an embodiment of the invention.

### DETAILED DESCRIPTION OF ILLUSTRATIVE EMBODIMENTS

Referring to the FIGURE, a clock signal generation circuit in an embodiment of the invention is illustrated. It includes a clock pulse generation unit 1, which generates a clock signal, and passes it to a driver (amplifier) 3. The driver 3 passes the clock signal to a clock output pin 5 of the integrated circuit, from where it is transmitted to a load, indicated generally as 7. The load 7 may include a capacitative component Cj and a resistive component R. Generally, the capacitance is much more important than the resistance in determining the power load from the clock output pin 5 since the resistance is typically very high when the load 7 is one or more integrated circuits.

In the embodiment, the driver 3 passes the clock signal to the clock output pin 5 via a load measurement circuit 4 including a sensing resistor 9. The voltages at the two sides of the resistor 9 are input to a differential amplifier 11, which outputs a load value that indicates the load being drawn by the load 7.

The load signal is input to a comparison circuit 13, including a first comparator that compares the load signal to a “low” load threshold value 17. The output of the first comparator 15 is high if and only if the load value is below the “low” load threshold.

The comparison circuit 13 further includes a second comparator 19, which compares the load signal output by the differential amplifier 11 to a “high” load threshold value 21. The output of the second comparator 19 is high if and only if the load value is above the “high” load threshold.

The comparison circuit 13 further includes an OR gate 23, which receives the output of the comparators 15, 19 and transmits its output to the clock signal generation unit 1. In the case that the output of the OR gate 23 is logic high (indicating that the load value output by the differential amplifier is out of the range between the thresholds 17, 21), the clock signal generation unit 1 is designed to stop generating the clock signal.

The “low” load threshold value 17 is lower than the “high” load threshold value 21, and may be zero. However, more preferably, it corresponds to the load that would be expected if the load is non-zero, e.g., equal to the load value which would be obtained if the capacitance Cj is 4 pF (and R is infinite).

The designer of a system containing the integrated circuit may be permitted to change the values of the thresholds. This may be done, for example, if the threshold values 17, 21 are defined by writable memories in the integrated circuit (not shown in the FIGURE), which can be programmed by appropriate voltage inputs to the integrated circuit or even by software operations performed in the integrated circuit. The designer of the chip will typically select one or both of the threshold values 17, 21 by experimentation (e.g., when the operation of the circuit is simulated in software during a design stage).

The driver 3 generates a non-zero voltage when the clock generator is turned off, so that there is a load, and the comparison circuit can detect when the load changes to enter the range from “low” load to “high” load.

Although only a single embodiment of the invention has been described in detail, many variations are possible within the scope of the invention. For example, the output of the OR gate 23 may not be transmitted to the clock signal generator unit 1, but instead to a switch located between the clock signal generator unit 1 and the driver 3. The switch is arranged to transmit the clock signal from the clock signal generator unit 1 to the driver 3 if and only if the output of the OR gate 23 is low.

What is claimed is:

1. An integrated circuit comprising:
a clock signal generation unit for generating a clock signal for transmission off the chip through a clock signal output pin;
a load measurement circuit which measures a load value indicative of power being drawn from the integrated circuit from the clock signal output pin; and
a comparison circuit for comparing the load value to one or more predetermined load thresholds and which is operative to prevent the clock signal from being transmitted through the clock signal output pin according to the result of the comparing.

2. An integrated circuit according to claim 1, wherein the comparison circuit is arranged to prevent the clock signal from being transmitted through the clock signal output pin when the measured load value is above a predetermined “high” load threshold.

3. An integrated circuit according to claim 1, wherein the comparison circuit is arranged to prevent the clock signal from being transmitted through the clock signal output pin when a measured conductance value is below a predetermined “low” load threshold.

4. An integrated circuit according to claim 1, wherein the load measurement circuit comprises a resistive element in series with the clock signal output pin and a differential amplifier for deriving a difference signal between voltages at sides of a resistive element.

5. An integrated circuit according to claim 1, further comprising a writable memory unit for storing the one or more predetermined load thresholds.

6. An integrated circuit according to claim 1, further comprising a switch coupled between the clock signal generation circuit and the clock signal output pin, wherein the clock signal is prevented from being transmitted by opening the switch.

7. An integrated circuit according to claim 1, wherein the one or more predetermined load thresholds comprises a load value with a capacitance of about 4 pF.

8. A system comprising an integrated circuit according to claim 1, and one or more load elements arranged to receive the clock signal from the clock signal output pin.

9. An integrated circuit comprising:
means for generating a clock signal for transmission off the chip through a clock signal output pin;
means for measuring a load value indicative of power being drawn from the integrated circuit from the clock signal output pin; and
means for comparing the load value to one or more predetermined load thresholds and for causing prevention of the clock signal from being transmitted through the clock signal output pin according to the result of the comparing.

10. An integrated circuit according to claim 9, wherein the means for comparing is arranged to prevent the clock signal from being transmitted through the clock signal output pin when the measured load value is above a predetermined “high” load threshold.

11. An integrated circuit according to claim 9, wherein the means for comparing is arranged to prevent the clock signal from being transmitted through the clock signal output pin when a measured conductance value is below a predetermined “low” load threshold.

12. An integrated circuit according to claim 9, wherein the means for measuring comprises a resistive element in series with the clock signal output pin and a differential amplifier for deriving a difference signal between voltages at sides of a resistive element.

13. An integrated circuit according to claim 9, further comprising means for storing the one or more predetermined load thresholds.

14. A method of operating a semiconductor chip, the method comprising:
generating a clock signal;
driving the clock signal off of the chip;
determining an amount of power being drawn from the clock signal; and
disabling the driving of the clock signal off of the chip if the determined amount of power differs from a threshold criteria.

15. The method of claim 14, wherein determining an amount of power comprises measuring a voltage drop across a resistive element.

16. The method of claim 14, wherein the driving of the clock signal is disabled when the determined amount of power exceeds the threshold criteria.

17. The method of claim 14, wherein determining an amount of power comprises measuring a conductance value and wherein the driving of the clock signal is disabled when the conductance value is below the threshold criteria.

18. The method of claim 14, wherein disabling the driving of the clock signal comprises stopping the generating of the clock signal.

19. The method of claim 14, wherein disabling the driving of the clock signal comprises preventing the clock signal from being driven off of the chip.

20. The method of claim 14, further comprising reading the threshold criteria from a location on the semiconductor chip.

21. An integrated circuit comprising:
a clock signal generation unit for generating a clock signal for transmission off the chip through a clock signal output pin;
a load measurement circuit which measures a load value indicative of power being drawn from the integrated circuit from the clock signal output pin; and
a comparison circuit for comparing the load value to a predetermined low threshold and a predetermined high threshold, the comparison circuit being arranged to prevent the clock signal from being transmitted through the clock signal output pin when the load value is above the high threshold or below the low threshold, the low and high thresholds being settable according to the integrated circuit operational limits.
